(19) United States
(12) Patent Application Publication
(10) Pub. No.: US 2022/0016936 A1
(43) Pub. Date: Jan. 20, 2022

(54) PNEUMATIC TIRE

(71) Applicant: The Yokohama Rubber Co., LTD., Tokyo (JP)

(72) Inventor: Yuki NAGAHASHI, Kanagawa (JP)

(21) Appl. No.: 17/309,669

(22) PCT Filed: Nov. 26, 2019
(86) PCT No.: PCT/JP2019/046143

§ 371 Date: Jun. 14, 2021

(30) Foreign Application Priority Data
Dec. 19, 2018 (JP) 2018-237680

(51) Int. Cl. B60C 11/03

(52) U.S. Cl. CPC B60C 11/0306; B60C 11/0304; B60C 2011/0348; B60C 2011/0353; B60C 2011/1209; B60C 2011/0381; B60C 2011/0388; B60C 2011/0395; B60C 2011/0355

(57) ABSTRACT

A pneumatic tire includes a first main groove on the outer side in the vehicle width direction of the equatorial plane, a second main groove closer to the equatorial plane than the first main groove, a third main groove on the inner side in the vehicle width direction of the equatorial plane, a fourth main groove farther from the equatorial plane than the third main groove, a first narrow groove between the third and fourth main grooves, and a first groove portion extending in the width direction between the first narrow groove and the fourth main groove and opening at one end to the fourth main groove. A relationship between the first main groove width G1, the third main groove width G3, and the fourth main groove width G4 satisfies 1.05≤G1/G3≤1.25, 1.10≤G4/G3≤1.30, and G3<G1<G4.

### TECHNICAL FIELD

The present technology relates to a pneumatic tire.

### BACKGROUND ART

With conventional pneumatic tires, there is a demand for providing steering stability on dry road surfaces and wet road surfaces and noise performance related to pass-by noise in a compatible manner. The technologies described in International Patent Publication No. WO 2015/005194 and Japan Patent No. 5695476 have been known conventional pneumatic tires that address this demand.

The pneumatic tires described in International Patent Publication No. WO 2015/005194 and Japan Patent No. 5695476 have room for improvement in the case of providing steering stability on dry road surfaces and wet road surfaces and noise performance related to pass-by noise in a compatible manner.

### SUMMARY

The present technology provides a pneumatic tire that can provide steering stability performance on dry road surfaces and wet road surfaces and noise performance in a highly compatible manner.

### Solution to Problem

To achieve the object described above, a pneumatic tire according to an aspect of the present technology includes a mounting direction indicator portion that indicates a mounting direction of a tire on a vehicle and a tread surface that is asymmetric on an outer side in a vehicle width direction and an inner side in the vehicle width direction with respect to a tire equatorial plane, the tread surface including a first main groove extending in a tire circumferential direction at a position on the outer side in the vehicle width direction of the tire equatorial plane, a second main groove extending in the tire circumferential direction at a position closer to the tire equatorial plane than the first main groove, a third main groove extending in the tire circumferential direction at a position on the inner side in the vehicle width direction of the tire equatorial plane, a fourth main groove extending in the tire circumferential direction at a position farther from the tire equatorial plane than the third main groove, a first narrow groove extending in the tire circumferential direction at a position between the third main groove and the fourth main groove, and a first groove portion extending in the tire width direction at a position between the first narrow groove and the fourth main groove and opening at one end to the fourth main groove, and when a groove width of the first main groove is G1, a groove width of the third main groove is G3, and a groove width of the fourth main groove is G4, relationships 1.05<G1/G3≤1.25, 1.10≤G4/G3≤1.30 being satisfied, and additionally, a relationship G3<G1<G4 being satisfied.

The first narrow groove is preferably provided in an inner land portion between the third main groove and the fourth main groove at a position where a ratio D2/D1 of a distance D2 from the third main groove to a length D1 in the vehicle width direction of the inner land portion is not less than 0.15 and not greater than 0.30.

A ratio Gr/G3 of a groove width Gr of the first narrow groove to the groove width G3 of the third main groove preferably satisfies a relationship 0.10≤Gr/G3≤0.30.

The first groove preferably includes a sipe and a first lug groove, one end of the first lug groove opens to the fourth main groove, a second end of the first lug groove is closed and connects to one end of the sipe, and a second end of the sipe connects to the first narrow groove.

A ratio D3/D1 of a length D3 in the vehicle width direction of the first lug groove to a length D1 in the vehicle width direction between the third main groove and the fourth main groove is preferably not less than 0.30 and not greater than 0.45.

The pneumatic tire preferably further includes a second lug groove extending toward the outer side in the vehicle width direction from a position on the outer side in the vehicle width direction with respect to the first main groove, and the second lug groove does not open to the first main groove.

The pneumatic tire preferably further includes a third lug groove extending toward the inner side in the vehicle width direction from a position on the inner side in the vehicle width direction with respect to the fourth main groove, and the third lug groove does not open to the fourth main groove.

The pneumatic tire preferably includes a fourth lug groove provided between the second main groove and the third main groove, one end of the fourth lug groove opens to the third main groove, and an other end of the fourth lug groove extends in the tire width direction without crossing the tire equator line between the second main groove and the third main groove.

The pneumatic tire preferably includes a fifth lug groove and a sixth lug groove provided in an outer land portion between the first main groove and the second main groove, the fifth lug groove and the sixth lug groove are alternately provided in the tire circumferential direction, the fifth lug groove and the sixth lug groove extend in the vehicle width direction, one end of the fifth lug groove opens to the second main groove, and one end of the sixth lug groove opens to the first main groove.

The pneumatic tire preferably includes a second narrow groove extending in the tire circumferential direction at a position on the inner side in the vehicle width direction with respect to the fourth main groove, and a ratio Gs/G3 of a groove width Gs of the second narrow groove to the groove width G3 of the third main groove satisfies a relationship 0.10≤Gs/G3≤0.30.

A third lug groove extending toward the inner side in the vehicle width direction from a position on the inner side in the vehicle width direction with respect to the fourth main groove preferably intersects the second narrow groove and further extends toward the inner side in the vehicle width direction, and the third lug groove does not open to the fourth main groove.

A distance from the tire equatorial plane to the second main groove is preferably shorter than a distance from the tire equatorial plane to the third main groove.

When a groove width of the second main groove is G2, a relationship 1.20≤G2/G3≤1.40 is preferably satisfied.

When a groove width of the second main groove is G2, a relationship G3<G1<G2 is preferably satisfied.

A groove width G2 of the second main groove and the groove width G4 of the fourth main groove preferably satisfy a relationship G4<G2.

The groove width G1 of the first main groove, a groove width G2 of the second main groove, and the groove width G3 of the third main groove preferably satisfy a relationship (G2−G1)/G3≥0.01.

A ratio of a maximum width to a minimum width of a width of an outer land portion between the first main groove and the second main groove, a width of a center land portion between the second main groove and the third main groove, and a width of an inner land portion between the third main groove and the fourth main groove is preferably not greater than 1.05.

At least one width among a width of an outer land portion between the first main groove and the second main groove, a width of a center land portion between the second main groove and the third main groove, and a width of an inner land portion between the third main groove and the fourth main groove is preferably different.

According to a pneumatic tire according to an embodiment of the present technology, steering stability on dry road surfaces and wet road surfaces and noise performance can be provided in a highly compatible manner.

### BRIEF DESCRIPTION OF DRAWINGS

FIG. 1 is a meridian cross-sectional view illustrating a pneumatic tire according to an embodiment of the present technology.

FIG. 2 is a developed view illustrating a tread pattern of the pneumatic tire according to the embodiment of the present technology.

FIG. 3 is an enlarged view of main parts of the tread pattern illustrated in FIG. 2.

FIG. 4 is an enlarged view of main parts of the tread pattern illustrated in FIG. 2.

### DETAILED DESCRIPTION

Pneumatic tires according to embodiments of the present technology are described in detail below with reference to the drawings. However, the present technology is not limited by the embodiments. Moreover, constituents of the embodiments include elements that are substitutable while maintaining consistency with the technology, and obviously substitutable elements. Furthermore, the plurality of modified examples described in the embodiments can be combined as desired within the scope apparent to one skilled in the art.

### Pneumatic Tire

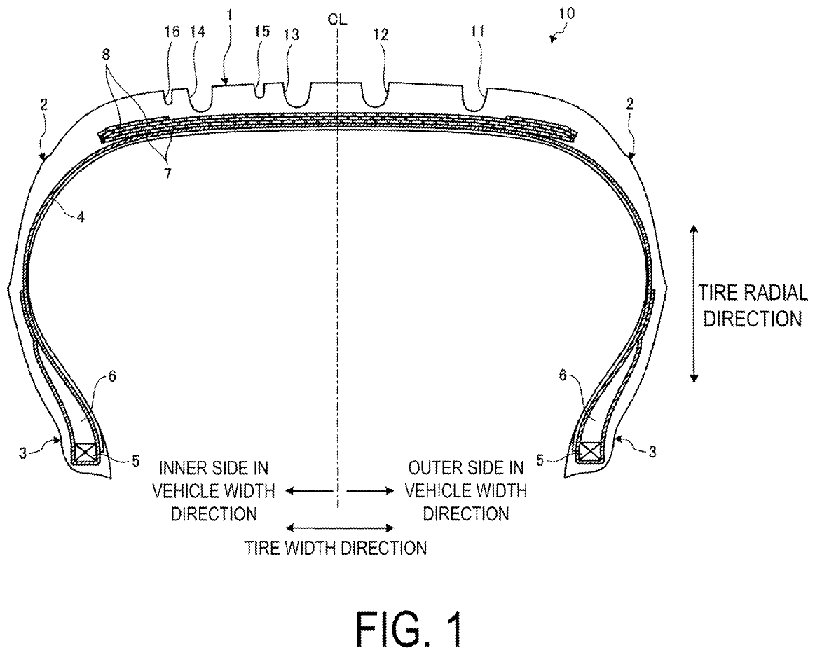

FIG. 1 is a cross-sectional view in a tire meridian direction illustrating a pneumatic tire according to an embodiment of the technology. FIG. 1 is a cross-sectional view of a half region in a tire radial direction. Additionally, FIG. 1 illustrates a radial tire for a passenger vehicle as an example of a pneumatic tire.

Herein, “tire radial direction” refers to the direction orthogonal to the rotation axis (not illustrated) of a pneumatic tire 10, “inner side in the tire radial direction” refers to the side toward the rotation axis in the tire radial direction, “outer side in the tire radial direction” refers to the side away from the rotation axis in the tire radial direction. In addition, “tire circumferential direction” refers to the circumferential direction with the rotation axis as the center axis. In addition, “tire width direction” refers to a direction parallel with the tire rotation axis. “Inner side in the tire width direction” refers to the side toward the tire equatorial plane CL in the tire width direction, and “outer side in the tire width direction” refers to the side away from the tire equatorial plane CL in the tire width direction. “Tire equatorial plane CL” refers to a plane orthogonal to the rotation axis of the pneumatic tire 10 that passes through the center of the tire width of the pneumatic tire 10. “Tire width” is the width in the tire width direction between components located on outer sides in the tire width direction, or in other words, the distance between the components that are the most distant from the tire equatorial plane CL in the tire width direction. “Tire equator line” refers to a line along a tire circumferential direction of a pneumatic tire 10 that lies on the tire equatorial plane CL. In the present embodiment, the tire equator line and the tire equatorial plane are denoted by the same reference sign CL.

In reference to the same drawing, “cross section in a tire meridian direction” refers to a cross section of the tire taken along a plane that includes the tire rotation axis (not illustrated). Reference sign CL denotes a tire equatorial plane and refers to a plane normal to the tire rotation axis that passes through the center point of the tire in a tire rotation axis direction. “Tire width direction” refers to the direction parallel with the tire rotation axis. “Tire radial direction” refers to the direction perpendicular to the tire rotation axis.

Furthermore, the inner side in the vehicle width direction and the outer side in the vehicle width direction are defined with respect to the vehicle width direction when the tire is mounted on the vehicle. Further, a pneumatic tire 10 includes a mounting direction indicator portion (not illustrated) that indicates a tire mounting direction with respect to the vehicle. The mounting direction indicator portion, for example, is composed of a mark or recesses/protrusions on a sidewall portion of the tire. For example, Economic Commission for Europe Regulation 30 (ECE R30) stipulates that the vehicle mounting direction indicator portion be provided on the sidewall portion on the outer side in the vehicle width direction in a case where the tire is mounted on a vehicle.

As illustrated in FIG. 1, the pneumatic tire 10 according to the present embodiment includes an annular tread portion 1 extending in a tire circumferential direction, a pair of sidewall portions 2, 2 disposed on both sides of the tread portion 1, and a pair of bead portions 3, 3 disposed on an inner side in a tire radial direction of the pair of sidewall portions 2.

A carcass layer 4 is mounted between the pair of bead portions 3, 3. The carcass layer 4 includes a plurality of reinforcing cords extending in the tire radial direction and is folded back around a bead core 5 disposed in each of the bead portions 3 from a tire inner side to a tire outer side. A bead filler 6 having a triangular cross-sectional shape and formed of a rubber composition is disposed on the outer circumference of the bead core 5.

On the other hand, a plurality of belt layers 7 are embedded on the outer circumferential side of the carcass layer 4 in the tread portion 1. Each of the belt layers 7 includes a plurality of reinforcing cords that are inclined with respect to the tire circumferential direction, and the reinforcing cords are disposed so as to intersect each other between the layers. In the belt layers 7, the inclination angle of the reinforcing cords with respect to the tire circumferential direction is set to fall within a range of from 10° to 40°, for example. Steel cords are preferably used as the reinforcing cords of the belt layers 7. To improve high-speed durability, at least one belt cover layer 8, formed by disposing reinforcing cords at an angle of, for example, not greater than 5° with respect to the tire circumferential direction, is disposed on an outer circumferential side of the belt layers 7. Organic fiber cords such as nylon and aramid are preferably used as the reinforcing cords of the belt cover layer 8.

Note that the tire internal structure described above represents a typical example for a pneumatic tire, but the pneumatic tire is not limited thereto.

### Tread Portion

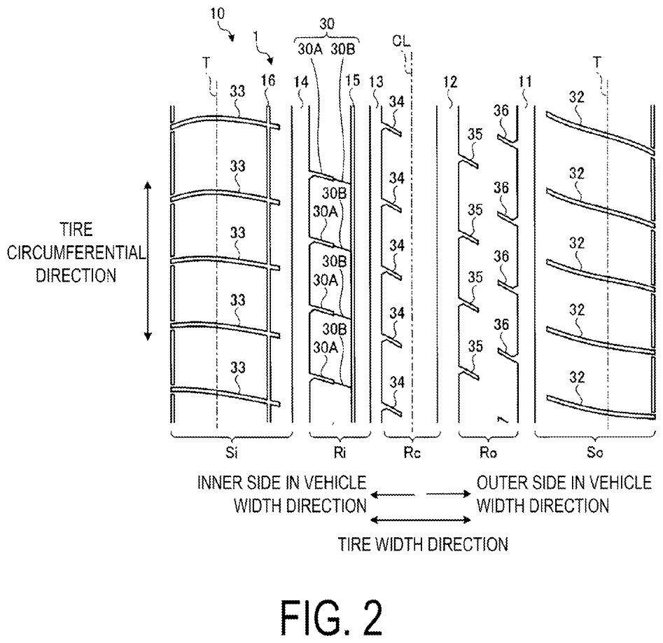

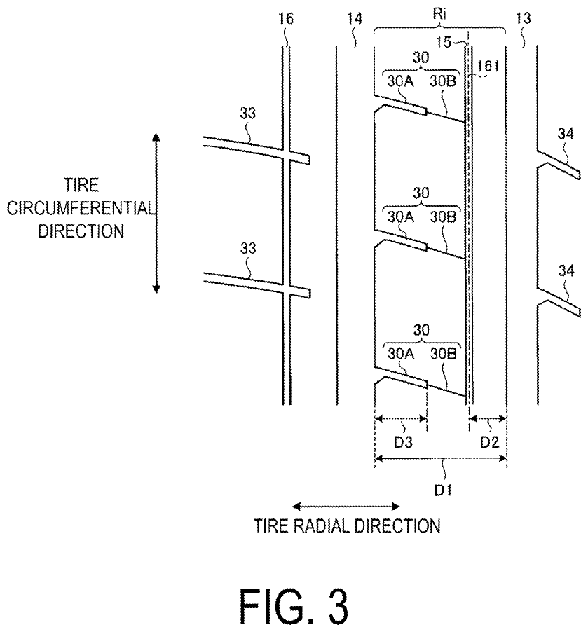

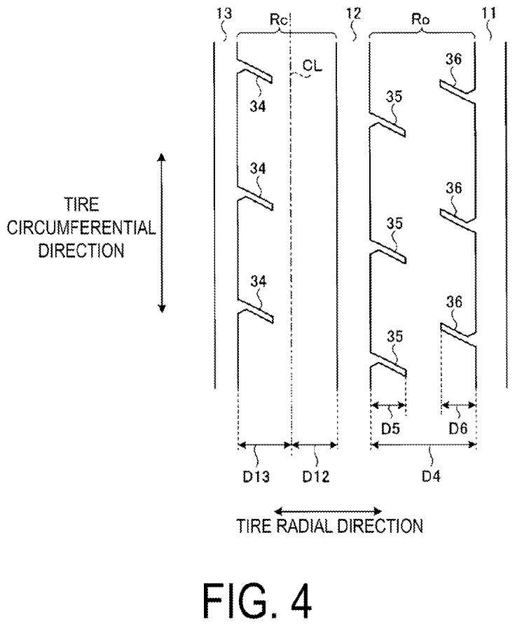

FIG. 2 is a plan view illustrating a tread surface of the pneumatic tire 10 illustrated in FIG. 1. FIG. 3 and FIG. 4 are partially enlarged views of the tread pattern of FIG. 2. The reference sign T denotes a tire ground contact edge in FIG. 2.

As illustrated in FIG. 2, the pneumatic tire 10 includes a first main groove 11 that extends in the tire circumferential direction at a position on the outer side in the vehicle width direction of the tire equatorial plane CL, a second main groove 12 that extends in the tire circumferential direction at a position closer to the tire equatorial plane CL than the first main groove 11, the tread portion 1 is provided with a third main groove 13 extending in the tire circumferential direction at a position on the inner side in the vehicle width direction of the tire equatorial plane CL, and a fourth main groove 14 extending in the tire circumferential direction at a position farther from the tire equatorial plane CL than the third main groove 13.

When the groove width of the first main groove 11 is G1, the groove width of the third main groove 13 is G3, and the groove width of the fourth main groove 14 is G4, each groove width preferably has a relationship such that 1.05≤G1/G3≤1.25 and 1.10≤G4/G3≤1.30. Additionally, the groove width G1 of the first main groove 11, the groove width G3 of the third main groove 13, and the groove width G4 of the fourth main groove 14 preferably have a relationship such that G3<G1<G4. Due to the groove width G1, the groove width G3, and the groove width G4 being in the relationship described above, steering stability on dry road surfaces and wet road surfaces can be improved.

In addition, when the groove width of the second main groove is G2, the relationship such that 1.20≤G2/G3≤1.40 is preferable. Due to the relationship between the groove width G2 and the groove width G3, steering stability on dry road surfaces and wet road surfaces can be improved.

Additionally, the groove width G1, groove width G2, and groove width G3 preferably have a relationship such that G3<G1<G2. Due to the groove width G1, the groove width G2, and the groove width G3 being in the relationship described above, steering stability on dry road surfaces and wet road surfaces can be improved. The groove width G1 of the first main groove 11, the groove width G2 of the second main groove 12, the groove width G3 of the third main groove 13, and the groove width G4 of the fourth main groove 14 are preferably different from each other. By varying all the widths of the main grooves in the circumferential direction and changing the resonance of the air passing through the tire groove, air column resonance can be disrupted to improve noise performance. In order to further improve the noise performance, it is preferable to have a relationship such that G4<G2 and G3<G1<G4<G2.

The groove width G1 of the first main groove 11, the groove width G2 of the second main groove 12, and the groove width G3 of the third main groove 13 preferably have a relationship such that (G2−G1)/G3≥0.01. In other words, the ratio (G2−G1)/G3 of the difference between the groove width G1 and the groove width G2 to the groove width G3 is preferably not less than 0.01. The groove width on the outer side in the tire width direction is narrower than the groove width on the center side close to the tire equatorial plane CL, and there is an effect of reducing vehicle pass-by noise without sacrificing wet steering stability performance.

The first main groove 11, the second main groove 12, the third main groove 13, and the fourth main groove 14 are circumferential grooves with a wear indicator that indicates the terminal stage of wear and typically have a groove width of 5.0 mm or greater and a groove depth of 7.5 mm or greater. Note that the groove width and groove depth of the first main groove 11, the second main groove 12, the third main groove 13, and the fourth main groove 14 are not limited to the ranges described above.

Moreover, “lug groove” refers to a lateral groove having a groove width of 2.0 mm or greater and a groove depth of 3.0 mm or greater. Additionally, “sipe”, which is described below, refers to a cut formed in a land portion that typically has a groove width of less than 1.5 mm.

### Land Portion, Lug Groove, Narrow Groove

The tread portion 1 is divided into a plurality of land portions by forming the first main groove 11, the second main groove 12, the third main groove 13, and the fourth main groove 14. Specifically, the tread portion 1 includes an outer shoulder land portion So located on the outer side the first main groove 11 in the vehicle width direction, an outer land portion Ro between the first main groove 11 and the second main groove 12, a center land portion Rc between the second main groove 12 and the third main groove 13, an inner land portion Ri between the third main groove 13 and the fourth main groove 14, and an inner shoulder land portion Si located on the inner side of the fourth main groove 14 in the vehicle width direction.

The tread portion 1 includes a first narrow groove 15 that extends in the tire circumferential direction in the inner land portion Ri, and a first groove portion 30 that opens to the first narrow groove 15 at one end and opens to the fourth main groove 14. Disposing the first narrow groove 15 extending in the tire circumferential direction on the inner side in the vehicle width direction and not disposing the circumferential narrow groove on the inner side in the vehicle width direction can ensure the rigidity of the land portion on the outer side in the vehicle width direction, and can ensure steering stability and improve drainage properties in a compatible manner. The first groove portion 30 communicates with the first narrow groove 15 and the fourth main groove 14. First groove portions 30 are provided at equal intervals in the tire circumferential direction.

A groove width Gr of the first narrow groove 15 and the groove width G3 of the third main groove 13 preferably have a relationship such that 0.10≤Gr/G3≤0.30. Disposing the first groove portion 30 extending in the tire width direction in the inner land portion Ri on the inner side in the vehicle width direction ensures steering stability. Furthermore, drainage properties can be ensured by connecting the first narrow groove 15 and the fourth main groove 14 by the first groove portion 30. By configuring the groove width Gr and the groove width G3 of the third main groove 13 into the relationship described above, drainage properties can be ensured while maintaining block rigidity.

The tread portion 1 includes, in the inner shoulder land portion Si, a second narrow groove 16 that extends in the tire circumferential direction at a position farther on the inner side in the vehicle width direction than the fourth main groove 14, and a third lug groove 33 that intersects the second narrow groove 16 and extends from a position on the inner side in the vehicle width direction of the fourth main groove 14 to the inner side in the vehicle width direction. By providing the second narrow groove 16 and the third lug groove 33 in the inner shoulder land portion Si, which tends to reduce drainage properties, wet performance can be compensated for. Furthermore, by disposing the lug grooves 33 in the inner land portions Ri, increases in the groove area of the outer land portion Ro on the outer side in the vehicle width direction and the center land portion Rc on the outer side in the vehicle width direction when cornering on dry road surfaces can be avoided, reduction in tread rigidity can be avoided, and deterioration in steering stability performance can be avoided.

The groove width Gs of the second narrow groove 16 and the groove width G3 of the third main groove 13 preferably have a relationship such that 0.10≤Gs/G3≤0.30. If the groove width Gs and the groove width G3 have such a relationship, the rigidity of the inner shoulder land portion Si can be ensured. Note that the third lug grooves 33 do not open to the fourth main grooves 14. By not communicating the third lug groove 33 of the inner shoulder land portion Si to the fourth main groove 14, noise performance can be improved.

The tread portion 1 includes, in the outer shoulder land portion So, a second lug groove 32 that extends toward the outer side in the vehicle width direction from a position on the outer side in the vehicle width direction of the first main groove 11 to the outer side in the vehicle width direction. Second lug grooves 32 are provided at equal intervals in the tire circumferential direction. Note that each of the second lug grooves 32 does not open to the first main groove 11. By not communicating the second lug groove 32 of the outer shoulder land portion So to the first main groove 11, noise performance can be improved.

The tread portion 1 includes a fifth lug groove 35 having one end open to the second main groove 12 and a sixth lug groove 36 having one end open to the first main groove 11. The fifth lug groove 35 extends in the tire width direction. Fifth lug grooves 35 are provided at equal intervals in the tire circumferential direction. The sixth lug groove 36 extends in the tire width direction. Sixth lug grooves 36 are provided at equal intervals in the tire circumferential direction. The other end of the fifth lug groove 35 terminates in the outer land portion Ro. The other end of the sixth lug groove 36 terminates in the outer land portion Ro. In the outer land portion Ro, the fifth lug grooves 35 and the sixth lug grooves 36 are alternately provided in the tire circumferential direction.

Note that the fifth lug groove 35 may or may not have a notch portion at one end that opens to the second main groove 12. The sixth lug groove 36 may or may not have a notch portion at one end that opens to the first main groove 11.

The tread portion 1 has a fourth lug groove 34 having one end open to the third main groove 13 in the central land portion Rc. The fourth lug groove 34 may or may not have a notch portion at one end that opens to the third main groove 13. Fourth lug grooves 34 are provided at equal intervals in the tire circumferential direction. The other end of the fourth lug groove 34 terminates in the central land portion Rc. The terminating end of the fourth lug groove 34 does not traverse the equatorial plane CL. In other words, the other end of the fourth lug groove 34 extends in the tire width direction without intersecting the tire equator line CL between the second main groove 12 and the third main groove 13.

Additionally, of the width of the outer land portion Ro, the width of the center land portion Rc, and the width of the inner land portion Ri, a ratio of the maximum width to the minimum width is preferably less than or equal to 1.05. The ratio being not greater than 1.05 means that the width of the outer land portion Ro, the width of the center land portion Rc, and the width of the inner land portion Ri are approximately identical. The width of each land portion is approximately identical, so the rigidity of each land portion is uniform. As a result, the uneven wear resistance performance is improved, and the uniformity of the pneumatic tire 10 can be improved.

However, all of the width of the outer land portion Ro between the first main groove 11 and the second main groove 12, a width of the center land portion Rc between the second main groove 12 and the third main groove 13, and a width of the inner land portion Ri between the third main groove 13 and the fourth main groove 14, all of which may be different widths or may be of identical width. At least one width of the width of the outer land portion Ro, the width of the central land portion Rc, and the width of the inner land portion Ri may be different from the width of the other. When the camber angle is set at an angle other than 0 degrees on the vehicle side due to the different widths of the land portions, handling performance can be adjusted by adjusting the width of the land portions.

In FIG. 3, the length of the inner land portion Ri in the vehicle width direction is D1, and the distance from the end portion on the inner side in the vehicle width direction of the third main groove 13 to the center line 161 of the first narrow groove 15 is D2. The ratio of the distance D2 to the length D1 is preferably greater than or equal to 0.15 and less than or equal to 0.30. In other words, the first narrow groove 15 is preferably provided at a position where the ratio D2/D1 of the distance D2 from the third main groove 13 to the length D1 in the vehicle width direction of the inner land portion Ri is not less than 0.15 and not greater than 0.30. By disposing the first narrow groove 15 in this range, the rigidity of the inner land portion Ri can be ensured.

The first groove portion 30 includes a first lug groove 30A and a sipe 30B. One end of the first lug groove 30A opens to the fourth main groove 14, and the other end of the first lug groove 30A is closed and communicates with one end of the sipe 30B. The other end of the sipe 30B connects to the first narrow groove 15. The sipe 30B has a narrower groove width than the first lug groove 30A. In other words, the first groove portion 30 has a configuration including a first lug groove 30A being a lug groove that is closed and a sipe 30B. By configuring the first groove portion 30 this way, the balance between drainage properties at a high-speed range (a larger groove surface area being advantageous) and adhesive friction at a low-speed range (a smaller groove surface area being advantageous), which affect steering stability performance on wet road surfaces, is optimized, and wet performance is improved. Moreover, drainage properties are improved due to the sipe 30B communicating with the first narrow groove 15. Furthermore, by not providing lug grooves between the first narrow groove 15 and the third main groove 13 in the inner land portion Ri, adhesive friction is improved and the wet performance at various speed ranges can be accommodated.

Here, a ratio D3/D1 of the length D3 in the vehicle width direction of the first lug groove 30A to the length D1 in the vehicle width direction between the third main groove 13 and the fourth main groove 14 is preferably not less than 0.30 and not greater than 0.45. If the value of the ratio D3/D1 is within the range described above, drainage properties can be improved while ensuring the rigidity of the inner land portion Ri.

As illustrated in FIG. 3, the groove width of the first groove portion 30 varies between one end that connects to the first narrow groove 15 and the other end that opens to the fourth main groove 14. In this way, in the first groove portion 30, the groove width of the portion closer to the inner side in the vehicle width direction is wider than the groove width of the portion near the tire equatorial plane CL. By increasing the groove width of the first groove portion 30 on the inner side in the vehicle width direction, drainage properties can be effectively improved.

Additionally, in FIG. 4, a ratio D5/D4 of the length D5 in the tire width direction of the fifth lug groove 35 to the width D4 of the outer land portion Ro is preferably not less than 0.30 and not greater than 0.40. If the value of the ratio D5/D4 is within the range described above, drainage properties can be improved while ensuring the rigidity of the outer land portion Ro.

Furthermore, in FIG. 4, a ratio D6/D4 of the length D6 in the tire width direction of the sixth lug groove 36 to the width D4 of the outer land portion Ro is preferably not less than 0.30 and not greater than 0.40. If the value of the ratio D6/D4 is within the range described above, drainage properties can be improved while ensuring the rigidity of the outer land portion Ro.

As illustrated in FIG. 4, in the pneumatic tire 10, the distance D12 from the tire equatorial plane CL to the second main groove 12 is shorter than the distance D13 from the tire equatorial plane CL to the third main groove 13. That is, the ratio of distance D12 to distance D13 is D12/D13<1.0. As a result, the pneumatic tire 10 has a tread surface that is asymmetric on the outer side in the vehicle width direction and the inner side in the vehicle width direction with respect to the tire equatorial plane CL.

As illustrated in FIG. 2, the tread portion 1 has a groove width that is narrower than the groove width of the main grooves 11˜14 in the region of the outer shoulder land portion So, and no circumferential narrow grooves extending in the tire circumferential direction are provided. By not providing the circumferential narrow groove in the outer shoulder land portion So that is the vehicle mounting outer side, noise performance is improved.

The groove width is the maximum distance between left and right groove walls at the groove opening portion and is measured when the tire is mounted on a specified rim, inflated to the specified internal pressure, and in an unloaded state. In configurations in which the land portions include notch portions or chamfered portions on the edge portions thereof, the groove width is measured with reference to the intersection points where the tread contact surface and extension lines of the groove walls meet, in a cross-sectional view normal to the groove length direction. Additionally, in a configuration in which the grooves extend in a zigzag-like or wave-like manner in the tire circumferential direction, the groove width is measured with reference to the center line of the amplitude of the groove walls.

The tire ground contact edge T is defined as the maximum width position in the tire axial direction of the contact surface between the tire and a flat plate when the tire is mounted on a specified rim, inflated to the specified internal pressure, placed perpendicular to the flat plate in a static state, and loaded with a load corresponding to the specified load.

“Specified rim” refers to an “applicable rim” defined by the Japan Automobile Tyre Manufacturers Association Inc. (JATMA), a “Design Rim” defined by the Tire and Rim Association, Inc. (TRA), or a “Measuring Rim” defined by the European Tyre and Rim Technical Organisation (ETRTO). Additionally, “specified internal pressure” refers to a “maximum air pressure” defined by JATMA, to the maximum value in “TIRE LOAD LIMITS AT VARIOUS COLD INFLATION PRESSURES” defined by TRA, or to “INFLATION PRESSURES” defined by ETRTO. Additionally, “specified load” refers to a “maximum load capacity” defined by JATMA, the maximum value in “TIRE LOAD LIMITS AT VARIOUS COLD INFLATION PRESSURES” defined by TRA, or “LOAD CAPACITY” defined by ETRTO. However, in the case of JATMA, for a passenger vehicle tire, the specified internal pressure is an air pressure of 180 kPa, and the specified load is 88% of the maximum load capacity.

### EXAMPLES

Table 1 to Table 5 are tables showing the results of performance tests of pneumatic tires according to embodiments of the technology. Evaluations of dry steering stability performance, wet steering stability performance, and noise performance of mutually different pneumatic tires were conducted for the performance tests. In these performance tests, a test tire having a size of 225/60R17 100H was mounted on a rim having a rim size of 17×7.5JJ, and inflated to an air pressure of 240 kPa. Additionally, a front engine-front drive (FF) sport utility vehicle (SUV) with an engine displacement of 2400 cc was used as a test vehicle.

In the evaluation of dry steering stability performance, the test vehicle traveled at a speed of from 60 km/h to 100 km/h on a flat circuit test course on dry road surfaces. Then the test driver performed a sensory evaluation regarding steering while lane changing and cornering and stability while traveling forward. Results of the evaluation are expressed as index values and evaluated with Conventional Example being assigned as the reference (100). In this evaluation, larger values are preferable.

In the evaluation of wet steering stability performance, the test vehicle was driven at 40 km/h on an asphalt road surface covered with 1 mm of water. Then the test driver performed a sensory evaluation regarding steering while lane changing and cornering and stability while traveling forward. Results of the evaluation are expressed as index values and evaluated with Conventional Example being assigned as the reference (100). In this evaluation, larger values are preferable.

The evaluation of noise performance was evaluated according to the loudness of the pass-by noise outside the vehicle measured according to the tire noise test method established in ECE R117-02 (ECE Regulation No. 117 Revision 2). In this test, the test vehicle was run sufficiently before the noise measurement section, the engine was stopped before the section, and the maximum noise level dB in the noise measurement section when the test vehicle was coasted (noise level in a frequency range of from 800 Hz to 1200 Hz) was measured at a plurality of speeds separated into 8 or more by approximately equal intervals in a speed range of ±10 km/h with respect to the reference speed, and the average was used as the pass-by noise outside the vehicle. The maximum noise level dB is the sound pressure dB (A) measured through a characteristic frequency correction circuit using a stationary microphone installed 7.5 m laterally from the travel center line and at a height of 1.2 m from the road surface at an intermediate point in the noise measurement section. The pass-by noise is expressed as an index with the measurement result being evaluated with Conventional Example being assigned as the reference (100). Larger values indicate smaller sound pressure dB and superior noise performance against pass-by noise.

The pneumatic tires of Examples 1 to 32 are pneumatic tires having the first groove portion 30 and the first narrow groove 15, and the relationship between the groove width G1 of the first main groove 11, the groove width G3 of the third main groove 13, and the groove width G4 of the fourth main groove 14 is such that 1.05≤G1/G3≤1.25 and 1.10≤G4/G3≤1.30, and furthermore G3<G1<G4.

Examples 1 to 32 were set as shown in Table 1 to Table 5. That is, the ratio D2/D1 being not less than 0.15 and not greater than 0.30 and otherwise; the ratio Gr/G3 having a relationship such that 0.10≤Gr/G3≤0.30 and otherwise; the ratio D2/D1 being not less than 0.30 and not greater than 0.45 and otherwise; there being a second lug groove 32, third lug groove 33, fourth lug groove 34, fifth lug groove 35 and sixth lug groove 36 and otherwise; there being a second narrow groove 16 and otherwise; the ratio Gs/G3 having a relationship such that 0.10≤Gs/G3≤0.30 and otherwise; the third lug groove 33 and the second narrow groove 16 intersecting and otherwise; the third lug groove 33 opening to the fourth main groove 14 and otherwise; the distance D12 from the tire equatorial plane CL to the second main groove 12 being shorter than the distance D13 from the tire equatorial plane CL to the third main groove 13 (ratio D12/D13<1.0) and otherwise; the ratio G2/G3 having a relationship such that 1.20<G2 and otherwise; the groove width G1, groove width G2, and groove width G3 having a relationship such that G3<G1<G2 and otherwise; the groove width G2 and groove width G4 having a relationship such that G4<G2 and otherwise; the groove width G1, groove width G2, and groove width G3 having a relationship such that (G2−G1)/G3≥0.01 and otherwise; the ratio of the maximum land portion width to the minimum land portion width being not greater than 1.05 and otherwise; and at least one of the widths of each land portion being different from the other widths or all being identical widths were each prepared.

In the pneumatic tire of Conventional Example, the groove widths G1 to G4 are identical and do not include the first groove portion 30, the first narrow groove 15, and the second narrow groove 16.

For comparison, the pneumatic tires of Comparative Example 1 and Comparative Example 2 were prepared. In the pneumatic tire of Comparative Example 1, the ratio G1/G3 was 1.10, the ratio G4/G3 was 1.20, the first groove portion 30 was included, the first narrow groove 15 was not included, and the groove widths G1, G3, and G4 had a relationship such that G3<G1<G4. In the pneumatic tire of Comparative Example 2, the ratio G1/G3 was 1.10, the ratio G4/G3 was 1.20, the first narrow groove 15 was included, the first groove 30 was not included, and the groove widths G1, G3, and G4 had a relationship such that G3<G1<G4.

These pneumatic tires were evaluated for dry steering stability performance, wet steering stability performance, and noise performance by the evaluation methods described above, and the results are shown in Table 1 to Table 5.

As shown Table 1 to Table 5, when the ratio D2/D1 was not less than 0.15 and not greater than 0.30; when the ratio Gr/G3 had a relationship such that 0.10≤Gr/G3≤0.30; when the ratio D3/D1 was not less than 0.30 and not greater than 0.45; when a second lug groove 32, a third lug groove 33, a fourth lug groove 34, a fifth lug groove 35, and a sixth lug groove 36 were included; when a second narrow groove 16 was included; when the ratio Gs/G3 had a relationship such that 0.10≤Gs/G3≤0.30; when the third lug groove 33 and the second narrow groove 16 intersected; when the third lug groove 33 opened to the fourth main groove 14; when the distance D12 from the tire equatorial plane CL to the second main groove 12 was shorter (ratio D12/D13<1.0); when the ratio G2/G3 had a relationship such that 1.20≤G2/G3≤1.40; when the groove width G1, groove width G2, and groove width G3 had a relationship such that G3<G1<G2; when the groove width G2 and groove width G4 had a relationship such that G4<G2; when the groove width G1, groove width G2, and groove width G3 had a relationship such that (G2−G1)/G3≥0.01; when the ratio of the maximum land portion width to the minimum land portion width was not greater than 1.05; and when at least one of the widths of each land portion was different from the other widths, favorable results for dry steering stability performance, wet steering stability performance, and noise performance were obtained.

TABLE 1-1

| | Conven- | Compar- | Compar- |
|---|---|---|---|
| | tional | ative | ative |
| | Exam- | Exam- | Exam- |
| | ple | ple 1 | ple 2 |
| Groove width | 1.00 | 1.10 | 1.10 |
| ratio G1/G3 | | | |
| Groove width | 1.00 | 1.20 | 1.20 |
| ratio G4/G3 | | | |
| First groove | No | Yes | No |
| portion 30 | | | |
| First narrow | No | No | Yes |
| groove 15 | | | |
| G3 < G1 < G4 | — | Yes | Yes |
| Ratio D2/D1 | — | — | — |
| Groove width | — | — | — |
| ratio Gr/G3 | | | |
| Ratio D3/D1 | — | — | — |
| Second lug | — | — | — |
| groove 32 | | | |
| Third lug | — | — | — |
| groove 33 | | | |
| Fourth lug | — | — | — |
| groove 34 | | | |
| Fifth lug | — | — | — |
| groove 35 | | | |
| and | | | |
| sixth lug | | | |
| groove 36 | | | |
| Second narrow | No | — | — |
| groove 16 | | | |
| Groove width | — | — | — |
| ratio Gs/G3 | | | |
| Intersection of | — | — | — |
| third lug | | | |
| groove 33 | | | |
| and | | | |
| second narrow | | | |
| groove 16 | | | |
| Third lug | — | — | — |
| groove 33 | | | |
| opens to | | | |
| fourth main | | | |
| groove 14 | | | |
| Ratio D12/D13 | 1.0 | 1.0 | 1.0 |
| Groove width | 1.00 | — | — |
| ratio G2/G3 | | | |
| G3 < G1 < G2 | — | — | — |
| G4 < G2 | — | — | — |
| Ratio | — | — | — |
| (G2 − G1)/G3 | | | |
| Ratio of | — | — | — |
| maximum land | | | |
| portion width | | | |
| to minimum | | | |
| land portion | | | |
| width | | | |
| Land width | — | — | — |
| relationship | | | |
| Dry steering | 100 | 103 | 103 |
| stability | | | |
| performance | | | |
| Wet steering | 100 | 100 | 101 |
| stability | | | |
| performance | | | |
| Noise | 100 | 100 | 98 |
| performance | | | |

TABLE 1-2

| | Exam- | Exam- | Exam- | Exam- | Exam- |
|---|---|---|---|---|---|
| | ple 1 | ple 2 | ple 3 | ple 4 | ple 5 |
| Groove width | 1.05 | 1.10 | 1.20 | 1.25 | 1.25 |
| ratio G1/G3 | | | | | |
| Groove width | 1.10 | 1.20 | 1.30 | 1.30 | 1.30 |
| ratio G4/G3 | | | | | |
| First groove | Yes | Yes | Yes | Yes | Yes |
| portion 30 | | | | | |
| First narrow | Yes | Yes | Yes | Yes | Yes |
| groove 15 | | | | | |
| G3 < G1 < G4 | Yes | Yes | Yes | Yes | Yes |
| Ratio D2/D1 | 0.20 | 0.20 | 0.20 | 0.20 | 0.15 |
| Groove width | 0.20 | 0.20 | 0.30 | 0.20 | 0.20 |
| ratio Gr/G3 | | | | | |
| Ratio D3/D1 | 0.35 | 0.35 | 0.35 | 0.35 | 0.35 |
| Second lug | No | No | No | No | No |
| groove 32 | | | | | |
| Third lug | No | No | No | No | No |
| groove 33 | | | | | |
| Fourth lug | No | No | No | No | No |
| groove 34 | | | | | |
| Fifth lug | No | No | No | No | No |
| groove 35 | | | | | |
| and | | | | | |
| sixth lug | | | | | |
| groove 36 | | | | | |
| Second narrow | No | No | No | No | No |
| groove 16 | | | | | |
| Groove width | No | No | No | No | No |
| ratio Gs/G3 | | | | | |
| Intersection of | No | No | No | No | No |
| third lug | | | | | |
| groove 33 | | | | | |
| and | | | | | |
| second narrow | | | | | |
| groove 16 | | | | | |
| Third lug | No | No | No | No | No |
| groove 33 | | | | | |
| opens to | | | | | |
| fourth main | | | | | |
| groove 14 | | | | | |
| Ratio D12/D13 | 1.0 | 1.0 | 1.0 | 1.0 | 1.0 |
| Groove width | 1.25 | 1.25 | 1.25 | 1.25 | 1.25 |
| ratio G2/G3 | | | | | |
| G3 < G1 < G2 | Yes | Yes | Yes | Yes | Yes |
| G4 < G2 | Yes | Yes | Yes | Yes | Yes |
| Ratio | 0.01 | 0.01 | 0.01 | 0.01 | 0.01 |
| (G2 − G1)/G3 | | | | | |
| Ratio of | 1.05 | 1.05 | 1.05 | 1.05 | 1.05 |
| maximum land | | | | | |
| portion width | | | | | |
| to minimum | | | | | |
| land portion | | | | | |
| width | | | | | |
| Land width | Differ- | Differ- | Differ- | Differ- | Differ- |
| relationship | ent | ent | ent | ent | ent |
| Dry steering | 102 | 105 | 105 | 105 | 104 |
| stability | | | | | |
| performance | | | | | |
| Wet steering | 100 | 100 | 101 | 102 | 102 |
| stability | | | | | |
| performance | | | | | |
| Noise | 102 | 105 | 105 | 105 | 105 |
| performance | | | | | |

TABLE 2

| | Exam- | Exam- | Exam- | Exam- | Exam- | Exam- | Exam- | Exam- |
|---|---|---|---|---|---|---|---|---|
| | ple 6 | ple 7 | ple 8 | ple 9 | ple 10 | ple 11 | ple 12 | ple 13 |
| Groove width | 1.25 | 1.25 | 1.10 | 1.10 | 1.10 | 1.20 | 1.10 | 1.10 |
| ratio G1/G3 | | | | | | | | |
| Groove width | 1.30 | 1.30 | 1.20 | 1.20 | 1.20 | 1.30 | 1.20 | 1.20 |
| ratio G4/G3 | | | | | | | | |
| First groove | Yes | Yes | Yes | Yes | Yes | Yes | Yes | Yes |
| portion 30 | | | | | | | | |
| First narrow | Yes | Yes | Yes | Yes | Yes | Yes | Yes | Yes |
| groove 15 | | | | | | | | |
| G3 < G1 < G4 | Yes | Yes | Yes | Yes | Yes | Yes | Yes | Yes |
| Ratio D2/D1 | 0.30 | 0.30 | 0.20 | 0.20 | 0.20 | 0.20 | 0.20 | 0.20 |
| Groove width | 0.20 | 0.10 | 0.20 | 0.30 | 0.30 | 0.30 | 0.20 | 0.20 |
| ratio Gr/G3 | | | | | | | | |
| Ratio D3/D1 | 0.35 | 0.35 | 0.35 | 0.35 | 0.35 | 0.35 | 0.30 | 0.45 |
| Second lug | No | No | No | No | No | No | No | No |
| groove 32 | | | | | | | | |
| Third lug | No | No | No | No | No | No | No | No |
| groove 33 | | | | | | | | |
| Fourth lug | No | No | No | No | No | No | No | No |
| groove 34 | | | | | | | | |
| Fifth lug | No | No | No | No | No | No | No | No |
| groove 35 | | | | | | | | |
| and | | | | | | | | |
| sixth lug | | | | | | | | |
| groove 36 | | | | | | | | |
| Second narrow | No | No | Yes | Yes | Yes | Yes | Yes | Yes |
| groove 16 | | | | | | | | |
| Groove width | No | No | 0.20 | 0.20 | 0.30 | 0.30 | 0.20 | 0.20 |
| ratio Gs/G3 | | | | | | | | |
| Intersection of | No | No | No | No | No | No | No | No |
| third lug | | | | | | | | |
| groove 33 | | | | | | | | |
| and | | | | | | | | |
| second narrow | | | | | | | | |
| groove 16 | | | | | | | | |
| Third lug | No | No | No | No | No | No | No | No |
| groove 33 | | | | | | | | |
| opens to | | | | | | | | |
| fourth main | | | | | | | | |
| groove 14 | | | | | | | | |
| Ratio D12/D13 | 1.0 | 1.0 | 1.0 | 1.0 | 1.0 | 1.0 | 1.0 | 1.0 |
| Groove width | 1.25 | 1.25 | 1.25 | 1.25 | 1.25 | 1.25 | 1.25 | 1.25 |
| ratio G2/G3 | | | | | | | | |
| G3 < G1 < G2 | Yes | Yes | Yes | Yes | Yes | Yes | Yes | Yes |
| G4 < G2 | Yes | Yes | Yes | Yes | Yes | Yes | Yes | Yes |
| Ratio | 0.01 | 0.01 | 0.01 | 0.01 | 0.01 | 0.01 | 0.01 | 0.01 |
| (G2 − G1)/G3 | | | | | | | | |
| Ratio of | 1.05 | 1.05 | 1.05 | 1.05 | 1.05 | 1.05 | 1.05 | 1.05 |
| maximum land | | | | | | | | |
| portion width | | | | | | | | |
| to minimum | | | | | | | | |
| land portion | | | | | | | | |
| width | | | | | | | | |
| Land width | Differ- | Differ- | Differ- | Differ- | Differ- | Differ- | Differ- | Differ- |
| relationship | ent | ent | ent | ent | ent | ent | ent | ent |
| Dry steering | 104 | 103 | 105 | 105 | 104 | 105 | 106 | 104 |
| stability | | | | | | | | |
| performance | | | | | | | | |
| Wet steering | 102 | 102 | 103 | 106 | 105 | 107 | 104 | 106 |
| stability | | | | | | | | |
| performance | | | | | | | | |
| Noise | 105 | 105 | 105 | 103 | 107 | 104 | 107 | 106 |
| performance | | | | | | | | |

TABLE 3

| | Exam- | Exam- | Exam- | Exam- | Exam- | Exam- | Exam- |
|---|---|---|---|---|---|---|---|
| | ple 14 | ple 15 | ple 16 | ple 17 | ple 18 | ple 19 | ple 20 |
| Groove width | 1.10 | 1.10 | 1.10 | 1.10 | 1.10 | 1.10 | 1.10 |
| ratio G1/G3 | | | | | | | |
| Groove width | 1.20 | 1.20 | 1.20 | 1.20 | 1.20 | 1.20 | 1.20 |
| ratio G4/G3 | | | | | | | |
| First groove | Yes | Yes | Yes | Yes | Yes | Yes | Yes |
| portion 30 | | | | | | | |
| First narrow | Yes | Yes | Yes | Yes | Yes | Yes | Yes |
| groove 15 | | | | | | | |
| G3 < G1 < G4 | Yes | Yes | Yes | Yes | Yes | Yes | Yes |
| Ratio D2/D1 | 0.20 | 0.20 | 0.20 | 0.20 | 0.20 | 0.20 | 0.20 |
| Groove width | 0.20 | 0.20 | 0.20 | 0.20 | 0.20 | 0.20 | 0.20 |
| ratio Gr/G3 | | | | | | | |
| Ratio D3/D1 | 0.35 | 0.35 | 0.35 | 0.35 | 0.35 | 0.35 | 0.35 |
| Second lug | No | No | Yes | Yes | Yes | Yes | Yes |
| groove 32 | | | | | | | |
| Third lug | No | Yes | No | Yes | Yes | Yes | Yes |
| groove 33 | | | | | | | |
| Fourth lug | No | Yes | Yes | No | Yes | Yes | Yes |
| groove 34 | | | | | | | |
| Fifth lug | No | No | No | No | No | Yes | Yes |
| groove 35 | | | | | | | |
| and | | | | | | | |
| sixth lug | | | | | | | |
| groove 36 | | | | | | | |
| Second narrow | Yes | Yes | Yes | Yes | Yes | No | Yes |
| groove 16 | | | | | | | |
| Groove width | 0.20 | 0.20 | 0.20 | 0.20 | 0.20 | 0.20 | 0.10 |
| ratio Gs/G3 | | | | | | | |
| Intersection of | No | No | No | No | No | No | No |
| third lug | | | | | | | |
| groove 33 | | | | | | | |
| and | | | | | | | |
| second narrow | | | | | | | |
| groove 16 | | | | | | | |
| Third lug | No | No | No | No | No | No | No |
| groove 33 | | | | | | | |
| opens to | | | | | | | |
| fourth main | | | | | | | |
| groove 14 | | | | | | | |
| Ratio D12/D13 | 1.0 | 1.0 | 1.0 | 1.0 | 1.0 | 1.0 | 1.0 |
| Groove width | 1.25 | 1.25 | 1.25 | 1.25 | 1.25 | 1.25 | 1.25 |
| ratio G2/G3 | | | | | | | |
| G3 < G1 < G2 | Yes | Yes | Yes | Yes | Yes | Yes | Yes |
| G4 < G2 | Yes | Yes | Yes | Yes | Yes | Yes | Yes |
| Ratio | 0.01 | 0.01 | 0.01 | 0.01 | 0.01 | 0.01 | 0.01 |
| (G2 − G1)/G3 | | | | | | | |
| Ratio of | 1.05 | 1.05 | 1.05 | 1.05 | 1.05 | 1.05 | 1.05 |
| maximum land | | | | | | | |
| portion width | | | | | | | |
| to minimum | | | | | | | |
| land portion | | | | | | | |
| width | | | | | | | |
| Land width | Differ- | Differ- | Differ- | Differ- | Differ- | Differ- | Differ- |
| relationship | ent | ent | ent | ent | ent | ent | ent |
| Dry steering | 105 | 104 | 104 | 104 | 104 | 104 | 105 |
| stability | | | | | | | |
| performance | | | | | | | |
| Wet steering | 104 | 105 | 105 | 106 | 107 | 107 | 107 |
| stability | | | | | | | |
| performance | | | | | | | |
| Noise | 108 | 107 | 107 | 106 | 106 | 106 | 106 |
| performance | | | | | | | |

TABLE 4

| | Exam- | Exam- | Exam- | Exam- | Exam- | Exam- | Exam- |
|---|---|---|---|---|---|---|---|
| | ple 21 | ple 22 | ple 23 | ple 24 | ple 25 | ple 26 | ple 27 |
| Groove width | 110 | 1.10 | 1.10 | 1.10 | 1.10 | 1.10 | 1.10 |
| ratio G1/G3 | | | | | | | |
| Groove width | 1.20 | 1.20 | 1.20 | 1.20 | 1.20 | 1.20 | 1.20 |
| ratio G4/G3 | | | | | | | |
| First groove | Yes | Yes | Yes | Yes | Yes | Yes | Yes |
| portion 30 | | | | | | | |
| First narrow | Yes | Yes | Yes | Yes | Yes | Yes | Yes |
| groove 15 | | | | | | | |
| G3 < G1 < G4 | Yes | Yes | Yes | Yes | Yes | Yes | Yes |
| Ratio D2/D1 | 0.20 | 0.20 | 0.20 | 0.20 | 0.20 | 0.20 | 0.20 |
| Groove width | 0.20 | 0.20 | 0.20 | 0.20 | 0.20 | 0.20 | 0.20 |
| ratio Gr/G3 | | | | | | | |
| Ratio D3/D1 | 0.35 | 0.35 | 0.35 | 0.35 | 0.35 | 0.35 | 0.35 |
| Second lug | Yes | Yes | Yes | Yes | Yes | Yes | Yes |
| groove 32 | | | | | | | |
| Third lug | Yes | Yes | Yes | Yes | Yes | Yes | Yes |
| groove 33 | | | | | | | |
| Fourth lug | Yes | Yes | Yes | Yes | Yes | Yes | Yes |
| groove 34 | | | | | | | |
| Fifth lug | Yes | Yes | Yes | Yes | Yes | Yes | Yes |
| groove 35 | | | | | | | |
| and | | | | | | | |
| sixth lug | | | | | | | |
| groove 36 | | | | | | | |
| Second narrow | Yes | Yes | Yes | Yes | Yes | Yes | Yes |
| groove 16 | | | | | | | |
| Groove width | 0.20 | 0.30 | 0.20 | 0.20 | 0.20 | 0.20 | 0.20 |
| ratio Gs/G3 | | | | | | | |
| Intersection of | No | No | Yes | Yes | Yes | Yes | Yes |
| third lug | | | | | | | |
| groove 33 | | | | | | | |
| and | | | | | | | |
| second narrow | | | | | | | |
| groove 16 | | | | | | | |
| Third lug | No | No | No | Yes | Yes | Yes | Yes |
| groove 33 | | | | | | | |
| opens to | | | | | | | |
| fourth main | | | | | | | |
| groove 14 | | | | | | | |
| Ratio D12/D13 | 1.0 | 1.0 | 1.0 | 1.0 | Less | Less | Less |
| | | | | | than | than | than |
| | | | | | 1.0 | 1.0 | 1.0 |
| Groove width | 1.25 | 1.25 | 1.25 | 1.20 | 1.20 | 1.25 | 1.40 |
| ratio G2/G3 | | | | | | | |
| G3 < G1 < G2 | Yes | Yes | Yes | Yes | Yes | Yes | Yes |
| G4 < G2 | Yes | Yes | Yes | Yes | Yes | Yes | No |
| Ratio | 0.01 | 0.01 | 0.01 | 0.01 | 0.01 | 0.01 | 0.01 |
| (G2 − G1)/G3 | | | | | | | |
| Ratio of | 1.05 | 1.05 | 1.05 | 1.05 | 1.05 | 1.05 | 1.05 |
| maximum land | | | | | | | |
| portion width | | | | | | | |
| to minimum | | | | | | | |
| land portion | | | | | | | |
| width | | | | | | | |
| Land width | Differ- | Differ- | Differ- | Differ- | Differ- | Differ- | Differ- |
| relationship | ent | ent | ent | ent | ent | ent | ent |
| Dry steering | 105 | 104 | 104 | 103 | 104 | 104 | 105 |
| stability | | | | | | | |
| performance | | | | | | | |
| Wet steering | 108 | 108 | 109 | 110 | 108 | 109 | 108 |
| stability | | | | | | | |
| performance | | | | | | | |
| Noise | 107 | 106 | 105 | 104 | 105 | 105 | 104 |
| performance | | | | | | | |

TABLE 5

| | Exam- | Exam- | Exam- | Exam- | Exam- |
|---|---|---|---|---|---|
| | ple 28 | ple 29 | ple 30 | ple 31 | ple 32 |
| Groove width | 1.10 | 1.10 | 1.10 | 1.10 | 1.10 |
| ratio G1/G3 | | | | | |
| Groove width | 1.20 | 1.20 | 1.20 | 1.20 | 1.20 |
| ratio G4/G3 | | | | | |
| First groove | Yes | Yes | Yes | Yes | Yes |
| portion 30 | | | | | |
| First narrow | Yes | Yes | Yes | Yes | Yes |
| groove 15 | | | | | |
| G3 < G1 < G4 | Yes | Yes | Yes | Yes | Yes |
| Ratio D2/D1 | 0.20 | 0.20 | 0.20 | 0.20 | 0.20 |
| Groove width | 0.20 | 0.20 | 0.20 | 0.20 | 0.20 |
| ratio Gr/G3 | | | | | |
| Ratio D3/D1 | 0.35 | 0.35 | 0.35 | 0.35 | 0.35 |
| Second lug | Yes | Yes | Yes | Yes | Yes |
| groove 32 | | | | | |
| Third lug | Yes | Yes | Yes | Yes | Yes |
| groove 33 | | | | | |
| Fourth lug | Yes | Yes | Yes | Yes | Yes |
| groove 34 | | | | | |
| Fifth lug | Yes | Yes | Yes | Yes | Yes |
| groove 35 | | | | | |
| and | | | | | |
| sixth lug | | | | | |
| groove 36 | | | | | |
| Second narrow | Yes | Yes | Yes | Yes | Yes |
| groove 16 | | | | | |
| Groove width | 0.20 | 0.20 | 0.20 | 0.20 | 0.20 |
| ratio Gs/G3 | | | | | |
| Intersection of | Yes | Yes | Yes | Yes | Yes |
| third lug | | | | | |
| groove 33 | | | | | |
| and | | | | | |
| second narrow | | | | | |
| groove 16 | | | | | |
| Third lug | Yes | Yes | Yes | Yes | Yes |
| groove 33 | | | | | |
| opens to | | | | | |
| fourth main | | | | | |
| groove 14 | | | | | |
| Ratio D12/D13 | Less | Less | Less | Less | Less |
| | than | than | than | than | than |
| | 1.0 | 1.0 | 1.0 | 1.0 | 1.0 |
| Groove width | 1.25 | 1.25 | 1.25 | 1.25 | 1.25 |
| ratio G2/G3 | | | | | |
| G3 < G1 < G2 | No | Yes | Yes | Yes | Yes |
| G4 < G2 | Yes | Yes | Yes | Yes | Yes |
| Ratio | 0.01 | 0.01 | 0.005 | 0.01 | 0.01 |
| (G2 − G1)/G3 | | | | | |
| Ratio of | 1.05 | 1.05 | 1.05 | 2.00 | 1.05 |
| maximum land | | | | | |
| portion width | | | | | |
| to minimum | | | | | |
| land portion | | | | | |
| width | | | | | |
| Land width | Differ- | Differ- | Differ- | Differ- | Iden- |
| relationship | ent | ent | ent | ent | tical |
| Dry steering | 105 | 106 | 105 | 104 | 106 |
| stability | | | | | |
| performance | | | | | |
| Wet steering | 108 | 108 | 107 | 108 | 107 |
| stability | | | | | |
| performance | | | | | |
| Noise | 104 | 106 | 105 | 105 | 105 |
| performance | | | | | |

1. A pneumatic tire, comprising:
a mounting direction indicator portion that indicates a mounting direction of a tire on a vehicle; and
a tread surface that is asymmetric on an outer side in a vehicle width direction and an inner side in the vehicle width direction with respect to a tire equatorial plane,
the tread surface comprising a first main groove extending in a tire circumferential direction at a position on the outer side in the vehicle width direction of the tire equatorial plane, a second main groove extending in the tire circumferential direction at a position closer to the tire equatorial plane than the first main groove, a third main groove extending in the tire circumferential direction at a position on the inner side in the vehicle width direction of the tire equatorial plane, a fourth main groove extending in the tire circumferential direction at a position farther from the tire equatorial plane than the third main groove, a first narrow groove extending in the tire circumferential direction at a position between the third main groove and the fourth main groove, and a first groove portion extending in the tire width direction at a position between the first narrow groove and the fourth main groove and opening at one end to the fourth main groove, and
when a groove width of the first main groove is G1, a groove width of the third main groove is G3, and a groove width of the fourth main groove is G4,
relationships 1.05≤G1/G3≤1.25, 1.10≤G4/G3≤1.30 being satisfied, and
additionally, a relationship G3<G1<G4 being satisfied.

2. The pneumatic tire according to claim 1, wherein the first narrow groove is provided in an inner land portion between the third main groove and the fourth main groove at a position where a ratio D2/D1 of a distance D2 from the third main groove to a length D1 in the vehicle width direction of the inner land portion is not less than 0.15 and not greater than 0.30.

3. The pneumatic tire according to claim 1, wherein a ratio Gr/G3 of a groove width Gr of the first narrow groove to the groove width G3 of the third main groove satisfies a relationship 0.10≤Gr/G3≤0.30.

4. The pneumatic tire according to claim 1, wherein the first groove comprises a sipe and a first lug groove, one end of the first lug groove opens to the fourth main groove, a second end of the first lug groove is closed and connects to one end of the sipe, and a second end of the sipe connects to the first narrow groove.

5. The pneumatic tire according to claim 4, wherein a ratio D3/D1 of a length D3 in the vehicle width direction of the first lug groove to a length D1 in the vehicle width direction between the third main groove and the fourth main groove is not less than 0.30 and not greater than 0.45.

6. The pneumatic tire according to claim 1, further comprising a second lug groove extending toward the outer side in the vehicle width direction from a position on the outer side in the vehicle width direction with respect to the first main groove, wherein
the second lug groove does not open to the first main groove.

7. The pneumatic tire according to claim 1, further comprising a third lug groove extending toward the inner side in the vehicle width direction from a position on the inner side in the vehicle width direction with respect to the fourth main groove, wherein
the third lug groove does not open to the fourth main groove.

8. The pneumatic tire according to claim 1, comprising a fourth lug groove provided between the second main groove and the third main groove, wherein
one end of the fourth lug groove opens to the third main groove,
and an other end of the fourth lug groove extends in the tire width direction without crossing the tire equatorial plane between the second main groove and the third main groove.

9. The pneumatic tire according to claim 1, comprising a fifth lug groove and a sixth lug groove provided in an outer land portion between the first main groove and the second main groove, wherein
the fifth lug groove and the sixth lug groove are alternately provided in the tire circumferential direction,
the fifth lug groove and the sixth lug groove extend in the vehicle width direction,
one end of the fifth lug groove opens to the second main groove, and
one end of the sixth lug groove opens to the first main groove.

10. The pneumatic tire according to claim 1, comprising a second narrow groove extending in the tire circumferential direction at a position on the inner side in the vehicle width direction with respect to the fourth main groove, wherein
a ratio Gs/G3 of a groove width Gs of the second narrow groove to the groove width G3 of the third main groove satisfies a relationship 0.10≤Gs/G3≤0.30.

11. The pneumatic tire according to claim 10, wherein a third lug groove extending toward the inner side in the vehicle width direction from a position on the inner side in the vehicle width direction with respect to the fourth main groove intersects the second narrow groove and further extends toward the inner side in the vehicle width direction, and
the third lug groove does not open to the fourth main groove.

12. The pneumatic tire according to claim 1, wherein a distance from the tire equatorial plane to the second main groove is shorter than a distance from the tire equatorial plane to the third main groove.

13. The pneumatic tire according to claim 1, wherein when a groove width of the second main groove is G2, a relationship 1.20≤G2/G3≤1.40 is satisfied.

14. The pneumatic tire according to claim 1, wherein when a groove width of the second main groove is G2, a relationship G3<G1<G2 is satisfied.

15. The pneumatic tire according to claim 1, wherein a groove width G2 of the second main groove and the groove width G4 of the fourth main groove satisfy a relationship G4<G2.

16. The pneumatic tire according to claim 1, wherein the groove width G1 of the first main groove, a groove width G2 of the second main groove, and the groove width G3 of the third main groove satisfy a relationship (G2−G1)/G3≥0.01.

17. The pneumatic tire according to claim 1, wherein a ratio of a maximum width to a minimum width of a width of an outer land portion between the first main groove and the second main groove, a width of a center land portion between the second main groove and the third main groove, and a width of an inner land portion between the third main groove and the fourth main groove is not greater than 1.05.

18. The pneumatic tire according to claim 1, wherein at least one width among a width of an outer land portion between the first main groove and the second main groove, a width of a center land portion between the second main groove and the third main groove, and a width of an inner land portion between the third main groove and the fourth main groove is different.
